(19) United States
(12) Patent Application Publication
(10) Pub. No.: US 2023/0101959 A1
(43) Pub. Date: Mar. 30, 2023

(54) Ring rolling machine with device for ring manipulation

(71) Applicant: SMS group GmbH, Düsseldorf (DE)

(72) Inventors: Dennis MICHL, Bochum (DE); Alexander NEUMANN, Bochum (DE); Andreas BRENNER, Dortmund (DE)

(73) Assignee: SMS group GmbH, Düsseldorf (DE)

(21) Appl. No.: 17/801,769

(22) PCT Filed: Feb. 23, 2021
(86) PCT No.: PCT/EP2021/054372

§ 371 Date: Aug. 23, 2022

(30) Foreign Application Priority Data
Feb. 25, 2020 (DE) 10 2020 202 406.5

(51) Int. Cl. B21H 1/12; B21H 9/00; B25J 11/00; B25J 9/00

(52) U.S. Cl. CPC B21H 1/12; B21H 9/00; B25J 9/0096; B25J 11/005

(57) ABSTRACT

A device (1) for rolling rings, comprising: a rolling device (10) with a main roll (11) and at least one mandrel roll (13a) onto which a ring is loadable, wherein the rolling device (10) is designed to roll the ring, with the mandrel roll (13a) impacting an interior face of the ring and the main roll (11) impacting an exterior face of the ring ;and a manipulator (20) comprising at least one robot (21) designed to manipulate the ring, comprising loading the ring onto the mandrel roll (13a) and/or unloading the ring from the mandrel roll (13a).

### TECHNICAL FIELD

The disclosure relates to a device for rolling rings, comprising a rolling device with a main roll and at least one mandrel roll, and a manipulator designed to manipulate the ring, comprising for example loading the ring onto the mandrel roll and/or unloading the ring from the mandrel roll.

### BACKGROUND

Among the devices for rolling rings, so-called “multi-mandrel ring rolling machines” are known. These have a main roll, rotatably mounted about a main roll axis, and a mandrel roller table rotatable about a table axis. A plurality of rolling stations, each having one mandrel roll, is typically arranged on the mandrel roller table. The main roll axis and the table axis run parallel but offset from one another, which means that the main axis is mounted eccentrically relative to the table axis.

A ring applied to the mandrel roller table in such a manner that the mandrel roll passes through the ring is rolled while the mandrel roller table rotates. The rolling process itself takes place through the resulting rolling gap between the main roll and the corresponding mandrel roll. The rotation of the mandrel roller table about the main roll changes the rolling gap from a maximum to a minimum. This continuously reduces the wall thickness of the workpiece, that is, an annular preform, which continuously increases the diameter of the workpiece.

If a plurality of rolling stations is arranged on the mandrel roller table, multi-stage ring rolling can be implemented in the case of different mandrel roll profiles or mandrel roll diameters. For this purpose, the ring is pre-rolled on a first station and then finish-rolled step-by-step on one or more further stations.

A multi-mandrel ring rolling machine of the type set out above is described, for example, in EP 2 933 037 A1. Further multi-mandrel ring rolling machines are known from DE 1 098 481 A and DE 1 602 661 A.

Usually, the loading of the ring rolling machine with a workpiece, positioning it if necessary, and unloading the finish-rolled workpiece are performed manually, but in some cases they are already automated or partially automated.

For example, the above-mentioned DE 1 098 481 A discloses a loading station and an unloading station, which can carry out the loading and unloading of the workpiece as a function of the roller table rotation. In this case, however, each rolling station is equipped with identical mandrel rolls, that is, multi-stage rolling with different mandrel roll configurations is not possible. A further disadvantage of the solution in accordance with DE 1 098 481 A is the complex mechanical structure and the fact that the turntable must be stopped to remove the end products. This is accompanied by a reduction in productivity.

In order to increase productivity, in a further development, means for unloading, that is, discharging the rolled rings, were integrated into the rolling station. Thereby, the ring can be unloaded at the unloading point by a tilting movement. In the process, an unloading device engages the underside of the ring and lifts it off the mandrel roll. Especially with profiled mandrel rolls, however, there is the problem that the ring can get stuck, causing the process to be interrupted and requiring manual intervention.

The above-mentioned DE 1 602 661 A describes a variation of this method with which the roller table is raised horizontally to unload the ring. A slider then pushes the ring off the table. However, one disadvantage of this solution is that, as in DE 1 098 481 A, multi-stage rolling is not possible.

### SUMMARY

One object of the disclosure is to provide an improved device for rolling rings, in particular to simplify the manipulation of the rings and/or to make it more flexible.

The object is achieved with a device for rolling rings as claimed. Advantageous further embodiments follow from the dependent claims, the following description, and the description of preferred exemplary embodiments.

The device for rolling rings has a rolling device with a main roll and at least one mandrel roll. A ring to be rolled can be loaded onto the mandrel roll, wherein the rolling device is designed to roll the ring with the mandrel roll impacting an interior face of the ring and the main roll impacting an exterior face of the ring. In other words, the mandrel roll can be loaded with a ring, that is, an annular preform, in such a manner that the mandrel roll passes through the ring. The rolling gap is located between the mandrel roll and the main roll, wherein the main roll impacts the exterior face or exterior surface of the ring and the mandrel roll on the interior face or interior surface of the ring.

It should be noted that, for the sake of linguistic simplicity, the workpiece to be rolled in all its processing stages, that is, both as a preform and in its finish-rolled form as well as in all intermediate steps, is mostly referred to herein as a “ring.”

The device further comprises a manipulator comprising at least one robot that is designed to manipulate the ring, comprising loading the ring onto the mandrel roll and/or unloading the ring from the mandrel roll.

As used herein, the term “robot” or “industrial robot” means a programmable machine that is autonomously capable of performing one or more ring manipulations. “Manipulation” as used herein does not mean shaping by rolling, but rather transporting the ring into the rolling device, that is, loading one or more mandrel rolls with a ring, and/or out of the rolling device, that is, unloading the finish-rolled ring, and/or within the rolling device, that is, transferring the ring from one rolling station to another rolling station.

As the manipulation of one or more rings is taken over by the robot, a specially developed, mechanically complex structure for loading the rolling device with rings and unloading the rings can be dispensed with. The rings can be reliably manipulated, wherein deviations with respect to the shape and position of the rings, for example, can be handled independently by the robot, by which downtimes of the device and manual intervention can be significantly reduced. The manipulator does not require any complex technical conversions for different products, product types, pick-up points, loading points, magazines and the like. Thus, the overall productivity of the device can be increased.

Preferably, the rolling device has a mandrel roller table rotatable about a table axis, wherein the mandrel roller table comprises a plurality of (for example four) rolling stations, each with a rotatable mandrel roll. The main roll axis, that is, the axis of rotation of the main roll, and the table axis preferably run parallel and in such a case are offset from one another in such a manner that the mandrel roller table with the mandrel rolls rotates eccentrically about the main roll, whereby different dimensions of the rolling gap between the main roll and a corresponding mandrel roll are set as a function of the angle of rotation of the mandrel roller table. In such a case, the rolling device has a design of the so-called “multi-mandrel table ring rolling machine,” and the manipulator implemented by the robot in such a case makes it possible to realize the manipulation of the rings without stopping the turntable. In addition, in the case of a plurality of rolling stations, manipulation by means of the robot is considerably simplified and made more flexible.

The mandrel rolls are preferably mounted at an identical distance from the table axis of the mandrel roller table, so that the rolling gap between the respective mandrel roll and the main roll changes periodically between a rolling gap maximum and a rolling gap minimum as a function of the angle of rotation of the mandrel roller table.

Preferably, the mandrel rolls of different rolling stations have at least partially different properties. For example, different diameters and/or different roll profiles can be realized. In this manner, multi-stage rolling can be realized. The manipulation of the rings, in particular the transfer of a ring from one rolling station to another rolling station, is considerably simplified by the manipulator implemented by means of the robot.

Preferably, for this reason, the robot is designed to transfer a ring from an mandrel roll of one rolling station (within one and the same rolling device) to an mandrel roll of another rolling station.

Preferably, the robot is designed to load a ring onto a loading position of the mandrel roll of a rolling station and to unload the ring from the mandrel roll of the rolling station at an unloading position. The loading position and unloading position can be flexibly changed and adjusted.

Preferably, the robot is designed to unload the ring from a magazine beforehand for loading onto the mandrel roll and/or to feed the ring to a magazine after unloading from the mandrel roll. in the simplest case, the one or more magazines may be trays. However, the term “magazine” also covers other means for providing the workpieces, that is, rings at the preform stage, and/or for taking off or transporting away the finish-rolled rings. For example, a magazine can be implemented by a container, a conveying device, such as a conveyor belt, or in some other manner, as long as the workpieces can be picked up by the robot from a pick-up point and, after processing, loaded onto a loading point from which the finished ring can be transported away.

Preferably, the robot comprises a gripper, which is designed to grip at least one ring and to perform the corresponding manipulation, along with at least one movable robot arm, preferably pivotable about one or more axes of rotation, to which the gripper is attached. Accordingly, the gripper, that is, the effector, of the robot has one or more gripping means in order to ensure the secure pick-up and loading of the rings. The gripping means can be movable (for example, sliding, pivoting, etc.), plier-like or even rigid, to the extent that the required manipulations can be carried out securely. If the manipulation includes the loading and unloading of the rolling device with a ring, a corresponding plier or gripper concept, as the case may be, can simultaneously create the possibility of picking up a preform from a further transfer point and loading the released rolling station.

Preferably, a plurality of different, for example product-specific, grippers is provided. Such a set of grippers can be stocked in a magazine. The robot is preferably designed to change the gripper automatically and autonomously, for example upon a product and/or tool change. In this manner, the rolling device can be made more flexible, by which it is applicable for different ring types, dimensions, materials and the like without significant changeover times.

Preferably, the robot is further designed to perform a tool change of the rolling device. In particular, the robot can be provided for exchanging one or more of the mandrel rolls, for example with the aid of a special gripper, which makes it possible to automatically exchange one or more of the mandrel rolls or to load the rolling stations with the required mandrel rolls upon a product change. The mandrel rolls that are not required can be stored in an mandrel roll store, preferably automatically by the robot. In this manner, unproductive auxiliary processing times can be significantly reduced, for example in the event of a technical failure or a product change.

Preferably, the robot is an industrial robot, which makes it easy to install and program the robot for the specific tasks relating to the rolling device. For this purpose, the robot is also preferably equipped with one or more sensors, such as cameras.

Further advantages and features of the present invention are apparent from the following description of preferred exemplary embodiments. The features described therein can be implemented alone or in combination with one or more of the features set forth above, provided the features do not contradict one another. The following description of the preferred exemplary embodiments is made with reference to the accompanying drawing.

Preferred further embodiments of the invention are explained in more detail by the following description of the figure.

### BRIEF DESCRIPTION OF THE DRAWINGS

FIG. 1 shows a device for rolling rings of the multi-mandrel table type with a manipulator realized by a robot.

### DETAILED DESCRIPTION

Preferred exemplary embodiments are described below with reference to the figure.

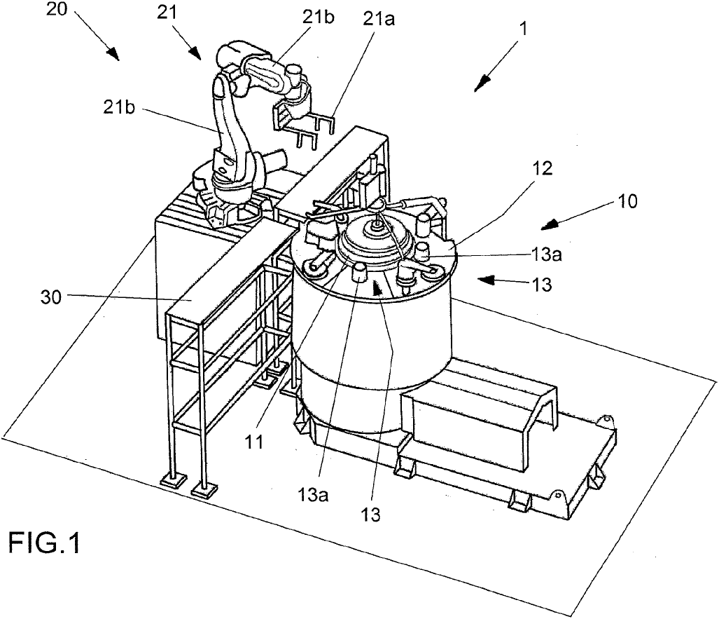

FIG. 1 shows a device 1 for rolling rings. For the sake of clarity, the workpieces themselves, that is, the rings in the various stages of processing, are not shown in the figure.

The device 1 is preferably of multi-mandrel table design, with which a main roll cooperates with a plurality of mandrel rolls integrated in a rotatable table. In such a case, the device 1 is also referred to as a “table ring rolling machine,” a “multi-mandrel ring rolling machine” or a “multi-mandrel table ring rolling machine.”

The device 1 in accordance with the present embodiment comprises a rolling device 10 and a manipulator 20.

The rolling device 10 comprises a main roll 11, which is rotatable about a main roll axis, along with an mandrel roller table 12, which is rotatable about a table axis. The mandrel roller table 12 comprises a plurality of, in the present embodiment four, rolling stations 13, each having a rotatable mandrel roll 13a. In other words, a plurality of rotatably mounted mandrel rolls 13a is located on the mandrel roller table 12 or is at least partially integrated therein, as the case may be.

The main roll axis and the table axis are not shown in FIG. 1 for the sake of clarity, but they are offset from one another in such a manner that the mandrel roller table 12 with the mandrel rolls 13a rotates eccentrically about the main roll 11, whereby different dimensions of the rolling gap between the main roll 11 and a corresponding mandrel roll 13a are set as a function of the angle of rotation of the mandrel roller table 12. The main roll 11 and the mandrel roller table 12 rotate preferably in the same direction. The actuators, for example one or more electric motors, for setting the main roll 11, the mandrel roller table 12 and, if necessary, the mandrel rolls 13a in rotation are located below the mandrel roller table 12, but are concealed by a housing section in FIG. 1.

The mandrel rolls 13a are mounted at a certain distance from the table axis of the mandrel roller table 12, so that the above-mentioned rolling gap between the respective mandrel roll 13a and the main roll 11 changes periodically between a rolling gap maximum and a rolling gap minimum as a function of the angle of rotation of the mandrel roller table 12. The distance of the respective mandrel roll 13a to the table axis is preferably adjustable, for example in the range of ±25 mm.

Particularly preferably, the plurality of rolling stations 13 of the mandrel roller table 12 is designed for multi-stage rolling; that is, the property of the mandrel rolls 13a of the various rolling stations 13 differs. In the simplest case, the diameters of the mandrel rolls 13a can differ in this respect, by which different rolling gap minima can be formed depending on the station and thus the ring can be gradually brought into its desired final shape. In this manner, particularly thin-walled rings can be produced in a material-friendly yet efficient manner. Alternatively or additionally, differently profiled mandrel rolls 13a can be used in order to specially structure the shape of the ring in this manner.

The mandrel roller table 12 can have further devices, such as relief means for reducing the forces acting on the mandrel rolls 13a, sensors for monitoring the rolling process and the like.

If an annular preform is loaded onto an mandrel roll 13a, it is rolled out with the circulation of the mandrel roller table 12 in the direction of circulation in the reducing rolling gap, until the rolling gap minimum is reached. With the further rotation of the mandrel roller table 12, the rolling gap widens again. In the case of single-stage rolling, the ring is finish-rolled after passing through the rolling gap minimum and can then be unloaded from the corresponding mandrel roll 13a. In the case of multi-stage rolling, the ring is loaded onto another rolling station 13 after such a rolling pass of an mandrel roll 13a, and the above process is repeated until, after passing through all the necessary rolling stations 13 (at least two rolling stations 13), the ring is finish-rolled.

It should be noted that, for the sake of linguistic simplicity, the workpiece to be rolled in all its processing stages, that is, both as a preform and in its finish-rolled form as well as in all intermediate steps, is mostly referred to herein as a “ring.”

In accordance with the preceding description, the ring undergoes a plurality of manipulations during the rolling process, including loading, unloading and any transfer of the ring from one rolling station 13 to another. Thus, “manipulation” herein does not mean shaping by rolling, but rather transporting the ring into the rolling device 10, out of the rolling device 10 and, if necessary, within the rolling device 10.

Such manipulation of the ring is performed by the manipulator 20. For this purpose, this comprises at least one robot 21, preferably an industrial robot, or is implemented by such a robot, as the case may be, Two or more robots 21 can also be provided, for example in the case of high cycle times that are not feasible or difficult to achieve with only one robot 21.

The robot 21 is designed to load a ring onto a loading position of the mandrel roll 13a of a rolling station 13, and to unload the ring from the mandrel roll 13a of the rolling station 13 at an unloading position. For this purpose, the ring at the preform stage can be taken from a magazine 30 and fed to such a magazine after completion of the rolling process.

In the simplest case, the one or more magazines 30 may be trays. However, the term “magazine” also covers other means for providing the workpieces, that is, rings at the preform stage, and/or for taking off or transporting away the finish-rolled rings. For example, a magazine 30 can be implemented by a container, a conveying device, such as a conveyor belt, or in some other manner, as long as the workpieces can be picked up by the robot 21 from a pick-up point and, after processing, loaded onto a loading point from which the finished ring can be transported away.

Particularly preferably, the robot 21 is further designed to transfer a ring from one rolling station 13 within the rolling device 10 to another rolling station 13. In such a case, the robot 21 can unload the ring from an mandrel roll 13a of a first rolling station 13 and load it onto an mandrel roll 13a of a second rolling station 13. The first and second rolling stations 13 can, but do not necessarily have to, be adjacent rolling stations 13. Depending on the number of rolling stations 13 to be passed through, this procedure can be extended by a third, fourth, etc. rolling station 13. In this manner, multi-stage rolling can be realized, wherein all manipulations of the ring can be carried out with only a single manipulator 20. However, a plurality of manipulators 20 with a total of a plurality of robots 21 can of course be applied if necessary.

The robot 21 has a gripper 21a, which is designed to grip at least one ring and perform the corresponding manipulation. For this purpose, the gripper 21a has one or more gripping means in order to ensure the secure pick-up and loading of the rings. The gripping means can be movable (for example, sliding, pivoting, etc.), plier-like or even rigid, to the extent that the required manipulations can be carried out securely. If the manipulation includes a loading and unloading of the rolling device with a ring, a corresponding plier or gripper concept, as the case may be, can simultaneously create the possibility of picking up a preform from a further transfer point and loading the released rolling station 13.

In order to be able to use the robot 21 for manipulating different ring products, a plurality of grippers 21a, which may be designed to be product-specific, are preferably provided. These can be stored in a magazine and automatically exchanged, that is, picked up and loaded, by the robot 21 upon a product change. With such a set of different grippers 21a, both the manipulability of the rings and the applicability of the rolling device 10 are further made more flexible.

The robot 21 further comprises at least one robot arm 21b to which the gripper 21a is attached. Preferably, the gripper 21a can be pivoted about one or more axes relative to the robot arm 21b. Preferably, two robot arms 21b are provided, which robot arms are pivotally connected to each other about one or more axes in order to realize a high number of degrees of freedom and thus a variety of manipulation options.

In accordance with a further embodiment, the robot 21 is further designed to perform a tool change of the rolling device 10. In particular, the robot 21 can be equipped with a special gripper 21a for exchanging the mandrel rolls 13a, which makes it possible to automatically exchange one or more of the mandrel rolls 13a or to load the rolling stations 13 with the required mandrel rolls 13a upon a product change. The mandrel rolls 13a that are not required can be stored in an mandrel roll store, preferably automatically by the robot 21. In this manner, unproductive auxiliary processing times can be significantly reduced, for example in the event of a technical failure or a product change.

To the extent applicable, any of the individual features shown in the exemplary embodiments may be combined and/or interchanged.

### LIST OF REFERENCE SIGNS

1 Device for rolling rings
10 Rolling device
11 Main roll
12 Mandrel roller table
13 Rolling station
13a Mandrel roll
20 Manipulator
21 Robot
21a Gripper
21b Robot arm
30 Magazine

1-10. (canceled)

11. A device (1) for rolling rings, comprising:
a rolling device (10) with
a main roll (11) and
at least one mandrel roll (13a) onto which a ring can be loaded,
wherein the rolling device (10) is designed to roll the ring with the mandrel roll (13a) impacting an interior face of the ring and the main roll (11) impacting an exterior face of the ring; and
a robot (21) designed to load the ring onto the mandrel roll (13a) and/or unload the ring from the mandrel roll (13a).

12. The device (1) according to claim 11,
wherein the main roll (11) is rotatable about a main roll axis and
wherein the rolling device (10) further comprises a mandrel roller table (12) rotatable about a table axis,
wherein the mandrel roller table (12) comprises the at least one mandrel roll (13a) in form of a plurality of rolling stations (13), each having one mandrel roll (13a), and
wherein the main roll axis and the table axis run parallel and offset from one another in such a manner that the mandrel roller table (12) with the mandrel rolls (13a) rotates eccentrically about the main roll (11), whereby different dimensions of a rolling gap between the main roll (11) and a corresponding mandrel roll (13a) are set as a function of an angle of rotation of the mandrel roller table (12).

13. The device (1) according to claim 12,
wherein the mandrel rolls (13a) of different rolling stations (13) have different diameters and/or different roll profiles in order to realize multi-stage rolling.

14. The device (1) according to claim 12,
wherein the robot (21) is designed to transfer the ring from the mandrel roll (13a) of one of the plurality of rolling stations (13) to the mandrel roll (13a) of another of the plurality of rolling stations (13).

15. The device (1) according to claim 12,
wherein the robot (21) is designed to load the ring onto a loading position of the mandrel roll (13a) of one of the plurality of rolling stations (13) and to unload the ring from the mandrel roll (13a) of the one of the plurality of rolling stations (13) at an unloading position.

16. The device (1) according to claim 15,
wherein the robot (21) is designed
to unload the ring from a magazine (30) before loading onto the loading position and/or
to feed the ring to a magazine (30) after unloading from the unloading position.

17. The device (1) according to claim 11,
wherein the robot (21) comprises
a gripper (21a), which is designed to grip the ring, and
at least one movable robot arm (21b), pivotable about one or more axes of rotation, to which the gripper (21a) is attached.

18. The device (1) according to claim 17,
wherein a plurality of different grippers (21a) is provided, stocked in a magazine, and
wherein the robot (21) is designed to change the gripper (21a) automatically and autonomously.

19. The device (1) according to claim 11,
wherein the robot (21) is designed to perform a tool change of the rolling device (10).

20. The device (1) according to claim 11,
wherein the robot (21) is designed to change the at least one mandrel roll (13a).

21. The device (1) according to claim 11,
wherein the robot (21) is an industrial robot.
